(19) United States
(12) Patent Application Publication
(10) Pub. No.: US 2025/0313013 A1
(43) Pub. Date: Oct. 9, 2025

(54) PRINTING DEVICE

(71) Applicant: SEIKO EPSON CORPORATION, Tokyo (JP)

(72) Inventors: Yutaka NAGASHIMA, MATSUMOTO-SHI (JP); Satoru MIYAMOTO, MATSUMOTO-SHI (JP); Daisuke HIRUMA, MATSUMOTO-SHI (JP)

(21) Appl. No.: 19/097,023

(22) Filed: Apr. 1, 2025

(30) Foreign Application Priority Data
Apr. 4, 2024 (JP) 2024-060654

(51) Int. Cl. B41J 2/17; B41J 11/00; B41J 15/02; B41J 15/04; B41J 29/13; B41J 29/377

(52) U.S. Cl. CPC B41J 2/1714; B41J 11/002; B41J 15/02; B41J 15/048; B41J 29/13; B41J 29/377

(57) ABSTRACT

A printing device includes a head that is housed in a housing and that ejects liquid onto a medium; an opening and closing cover that has a first partition constituting a part of a top surface of the housing and a second partition constituting a part of a front side A of the housing, and opens and closes the housing; a suction section configured to suck the gas inside of the housing; an outer duct fixed to the second partition and communicating with the suction section; a mist filter arranged in the outer duct, wherein the outer duct has the opening and closing sections and, and the mist filters are detachably attached to the outer duct through the opening and closing sections.

The present application is based on, and claims priority from JP Application Serial Number 2024-060654, filed Apr. 4, 2024, the disclosure of which is hereby incorporated by reference herein in its entirety.

### BACKGROUND

### 1. Technical Field

The present disclosure relates to a printing device.

### 2. Related Art

JP-A-2008-80495 discloses a configuration of a liquid ejection device including a suction mechanism that causes ink mist floating without adhering to a paper sheet among ink droplets ejected from an inkjet head to adhere to a filter. The filter is inserted into a filter insertion port provided on a side surface of the apparatus. When the amount of mist adhering to the filter exceeds a predetermined amount, the user is notified in accordance with the data of the amount of adhering ink mist read from the IC chip attached to the filter.

However, in the method described in of JP-A-2008-80495, there is a problem in that a complicated configuration is required, for example, contact terminals that come into contact with and that are electrically connected to the IC-chip are provided at a back end section of the filter receiving section, which is connected to the filter insertion port.

### SUMMARY

A printing device includes: a head that is housed in a housing and that ejects liquid onto a medium; an opening and closing cover that includes a first partition forming a part of a top surface of the housing and a second partition forming a part of a front side of the housing, and that opens and closes the housing; a suction section configured to suck gas from inside the housing; a duct fixed to the second partition and communicated with the suction section; and a mist filter arranged in the duct, wherein the duct has an opening and closing section, and the mist filter is detachably attached to the duct through the opening and closing section.

### BRIEF DESCRIPTION OF THE DRAWINGS

FIG. 1 is a schematic diagram illustrating a configuration of a printing device.

FIG. 2 is a perspective view showing an appearance of the printing device.

FIG. 3 is a perspective view showing a state in which the opening and closing cover of the printing device shown in FIG. 2 is opened.

FIG. 4 is a perspective view showing configuration when an opening and closing cover is closed.

FIG. 5 is a perspective view showing configuration when an opening and closing cover is open.

FIG. 6 is a perspective view showing configuration of an inner duct and a vertical duct.

FIG. 7 is a perspective view showing configuration of an opening and closing cover and an opening and closing section.

FIG. 8 is a perspective view of the opening and closing cover as viewed from the rear surface side.

FIG. 9 is a perspective view showing configuration of a suction section and an outer duct.

FIG. 10 is cross-sectional view showing a configuration of an inner duct and a vertical duct.

FIG. 11 is a perspective view of a configuration around a suction section viewed via a window of the top surface.

### DESCRIPTION OF EMBODIMENTS

Hereinafter, a configuration of a printing device 1 will be described with reference to the drawings. In each of the following drawings, three axes orthogonal to each other are described as an X axis, a Y axis, and a Z axis. It is assumed that a direction along the X axis is an “X direction”, a direction along the Y axis is a “Y direction”, a direction along the Z axis is a “Z direction”, a direction of an arrow is a +direction, and a direction opposite to the +direction is a −direction. A view from the +Z direction or the −Z direction is also referred to as a plan view shape or a plane.

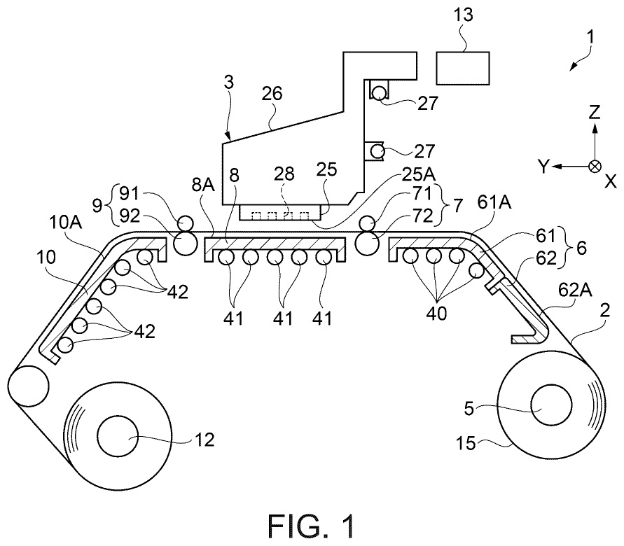

First, a configuration of the printing device 1 will be described with reference to FIG. 1.

As shown in FIG. 1, the printing device 1 includes a printing section 3 and a control unit 13. The printing section 3 performs printing by adhering ink to medium 2. The control unit 13 is a controller that controls the printing device 1. The printing device 1 is an inkjet type printer which prints an image such as a character or a photograph on the medium 2 by ejecting ink, which is an example of a liquid, onto the medium 2 such as a paper sheet which is transported. The printing section 3 is a serial type that performs printing while reciprocating in the width direction of the medium 2. The printing section 3 may be configured as a line type provided over the width direction of medium 2.

The printing device 1 includes the printing section 3, a feeding shaft 5, an upstream support section 6, an upstream transport section 7, a platen 8, a downstream transport section 9, a downstream support section 10, a winding shaft 12, and the control unit 13. The upstream support section 6, the upstream transport section 7, the platen 8, the downstream transport section 9, and the downstream support section 10 are located on a transport path along which the medium 2 is transported.

The feeding shaft 5 is a rod-shaped member extending along the X axis. The feeding shaft 5 is supported by a frame or the like (not shown) at both end sections in the ±X direction. The feeding shaft 5 rotatably supports a roll 15 formed by winding and stacking the elongated medium 2 into a cylindrical shape. The feeding shaft 5 rotates to feed the medium 2 from the roll 15 toward the upstream support section 6.

The upstream support section 6, the platen 8, and the downstream support section 10 are members that support the elongated medium 2 that is transported in the transport direction. The medium 2 is transported along the surfaces of the upstream support section 6, the platen 8, and the downstream support section 10. A direction along the surfaces of the upstream support section 6, the platen 8, and the downstream support section 10 is the transport direction of the medium 2. The transport direction intersects the X axis. The upstream support section 6, the platen 8, and the downstream support section 10 are fixed to a frame or the like (not shown) that supports the entire printing device 1.

The upstream support section 6 includes an upstream heater support section 61, an upstream guide support section 62, and an upstream heater section 40. The upstream support section 6 supports a portion of the medium 2 on the upstream side in the transport direction with respect to a portion facing the printing section 3. The platen 8 is located downstream of the upstream support section 6 in the transport direction. The medium 2 supported by the upstream support section 6 is transported to the platen 8 by the upstream transport section 7. The upstream transport section 7 is located downstream of the upstream support section 6 in the transport direction. The upstream transport section 7 is positioned upstream of the platen 8 in the transport direction.

The upstream transport section 7 includes a first roller 71 and a second roller 72. The first roller 71 and the second roller 72 each extend along the X axis. The upstream transport section 7 includes a motor (not illustrated). The power from the motor is transmitted to the second roller 72. The second roller 72 is rotatable using power from a motor. The medium 2 is pinched between the first roller 71 and the second roller 72. The medium 2 can be transported by rotating the second roller 72 while it is pinched between the first roller 71 and the second roller 72. The upstream transport section 7 transports the medium 2 toward the platen 8.

In the printing device 1, the second roller 72 is a drive roller, and the first roller 71 is a driven roller. The drive roller is rotationally driven by power from a motor. The driven roller follows the rotary driving of the drive roller. However, either the first roller 71 or the second roller 72 may be a drive roller or a driven roller. Pinching the medium 2 between the first roller 71 and the second roller 72 is also referred to as nipping. In the printing device 1, by separating the first roller 71 from the second roller 72, the nipping of the medium 2 by the first roller 71 and the second roller 72 can be released.

In the printing device 1, the nipping can be released by raising the first roller 71 with respect to the second roller 72. By lowering the first roller 71 from the nip released state, the state can be changed to the nipping state. The nipping state and the nip released state are not related to the presence or absence of the medium 2. That is, regardless of whether the medium 2 is present or not, the nip released state is when the first roller 71 is raised relative to the second roller 72. Similarly, regardless of the presence or absence of the medium 2, a state in which the first roller 71 is lowered from the nip released state is the nipping state. For example, when a new roll 15 is set on the feeding shaft 5, the nip is released in order to pass the leading end of the medium 2 fed from the roll 15 between the first roller 71 and the second roller 72.

The platen 8 is positioned in the-Z direction of the printing section 3. The platen 8 faces the printing section 3 with the transport path interposed therebetween. The platen 8 supports a portion of the medium 2 on which printing is performed by the printing section 3. A support surface 8A facing the +Z direction of the platen 8 supports the medium 2. The support surface 8A is substantially horizontal. The platen 8 can apply a suction force to the medium 2. The surface of the platen 8 facing the printing section 3 is flat. The support surface 8A of the platen 8 extends over a range in which printing can be performed by the printing section 3. The medium 2 may be sucked to the support surface 8A of the platen 8 by sucking air through a plurality of suction holes formed in the support surface 8A of the platen 8 by a suction fan.

The printing section 3 includes a head 25, a carriage 26, and a guide shaft 27. A plurality of nozzles 28 for ejecting ink are formed in the head 25. The plurality of nozzles 28 are opened in a nozzle surface 25A of the head 25. The guide shaft 27 is a rod-shaped member extending along the X axis. The guide shaft 27 is supported by a frame or the like (not shown) at both end sections in the ±X direction. The guide shaft 27 guides the movement of the carriage 26.

The carriage 26 holds the head 25 and reciprocates the head 25 in the ±X direction along the guide shaft 27 by the drive of a drive mechanism (not shown). The head 25 performs printing on the medium 2 by ejecting ink toward the medium 2 while moving. In the printing device 1, printing is performed by ejecting ink from the head 25 toward a region of the medium 2 that overlaps the platen 8.

The medium 2 supported by the platen 8 is transported to the downstream support section 10 by the downstream transport section 9. The medium 2 is transported in the +Y direction while being supported by the support surface 8A of the platen 8. The downstream transport section 9 is located downstream of the platen 8 in the transport direction. The downstream transport section 9 is located upstream of the downstream support section 10 in the transport direction.

The downstream transport section 9 includes a third roller 91 and a fourth roller 92. The third roller 91 and the fourth roller 92 each extend along the X axis. The downstream transport section 9 includes a motor (not shown). The power from the motor is transmitted to the fourth roller 92. The fourth roller 92 is rotatable by the power from the motor. The medium 2 is nipped between the third roller 91 and the fourth roller 92. The downstream transport section 9 can transport the medium 2 by rotating the fourth roller 92 in a state where the medium 2 is nipped between the third roller 91 and the fourth roller 92. The downstream transport section 9 transports the medium 2 toward the downstream support section 10.

The downstream support section 10 is located downstream of the platen 8 in the transport direction. The downstream support section 10 supports a portion of the medium 2 on the downstream side in the transport direction from a portion facing the printing section 3.

The winding shaft 12 is located downstream of the printing section 3 in the transport direction. The winding shaft 12 winds the medium 2 being transported. The winding shaft 12 is located downstream of the downstream support section 10 in the transport direction. The medium 2 is transported along the downstream support section 10 and then wound by the winding shaft 12.

The printing device 1 includes the upstream heater section 40, a print heater section 41, and a downstream heater section 42. The upstream heater section 40 is provided in the upstream support section 6. The upstream heater section 40 heats the medium 2 supported by a first support surface 61A via the upstream support section 6. The print heater section 41 is provided on the platen 8. The print heater section 41 heats the medium 2 supported on the support surface 8A via the platen 8. The downstream heater section 42 is provided in the downstream support section 10. The downstream heater section 42 heats the medium 2 supported by a downstream support surface 10A via the downstream support section 10.

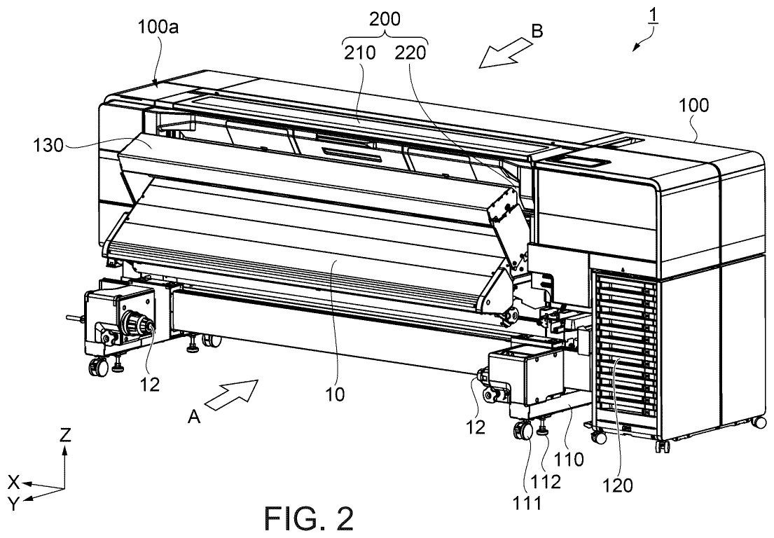

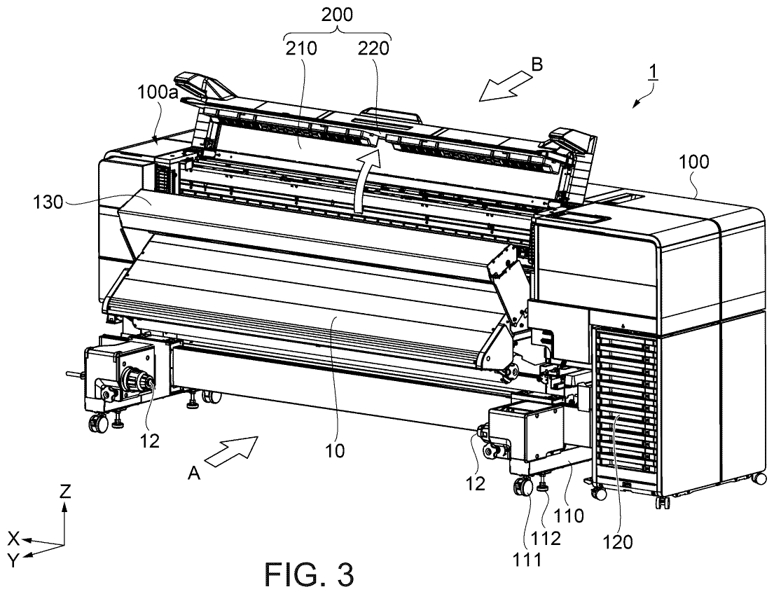

Next, a configuration of the printing device 1 will be described with reference to FIGS. 2 and 3.

As shown in FIGS. 2 and 3, the printing device 1 includes a housing 100. Leg frames 110 are attached to portions near both ends of the housing 100 in the X direction. A caster 111 and an adjuster 112 are provided below the leg frame 110. By using the caster 111, the printing device 1 can be easily moved. By using the adjuster 112, it is possible to adjust the heights of a plurality of places and to suitably install the printing device 1 on the installation surface.

As described above, the housing 100 includes the printing section 3, the upstream transport section 7, the platen 8, the downstream transport section 9, and the control unit 13. As described above, the printing device 1 includes the feeding shaft 5, the upstream support section 6, the downstream support section 10, and the winding shaft 12 (shown in FIG. 1).

The printing device 1 includes the head 25 (shown in FIG. 1) that ejects ink. The head 25 is accommodated in the housing 100. The printing device 1 includes a liquid supply section 120 that supplies ink to the head 25. The liquid supply section 120 and the head 25 are configured to supply ink via a liquid supply path (not shown).

The printing device 1 performs printing by ejecting ink onto the medium 2 while reciprocating the head 25 in the X direction. A blower section 130 that blows an airflow onto the medium 2 is provided in a portion of the printing device 1 that faces the downstream support section 10. The ink ejected the onto medium 2 can be dried by blowing an air flow onto the medium 2.

On the front side A of the housing 100, an opening and closing cover 200 including a first partition 210 constituting a part of a top surface 100a of the housing 100 and a second partition 220 constituting a part of the front side A of the housing 100 is provided. The front side A is a state in which the printing device 1 is viewed from the +Y direction to the −Y direction. The rear surface side B is a state in which the printing device 1 is viewed from the −Y direction to the +Y direction. The opening and closing cover 200 operates around a rotation shaft (not shown) to open and close part of the housing 100 (shown in FIG. 3).

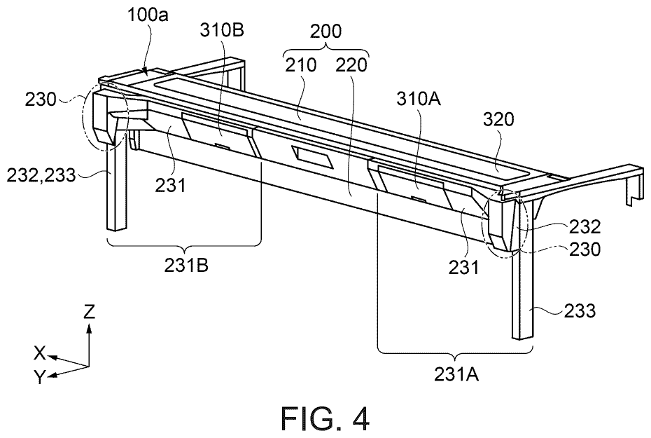

Next, configurations of the opening and closing cover 200, ducts 231 and 232, and a mist filter 311 will be described with reference to FIGS. 4 to 11.

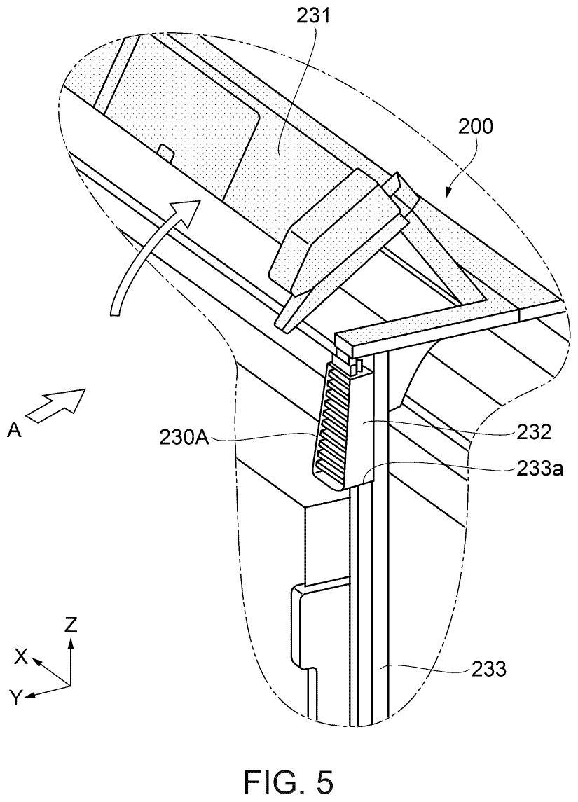

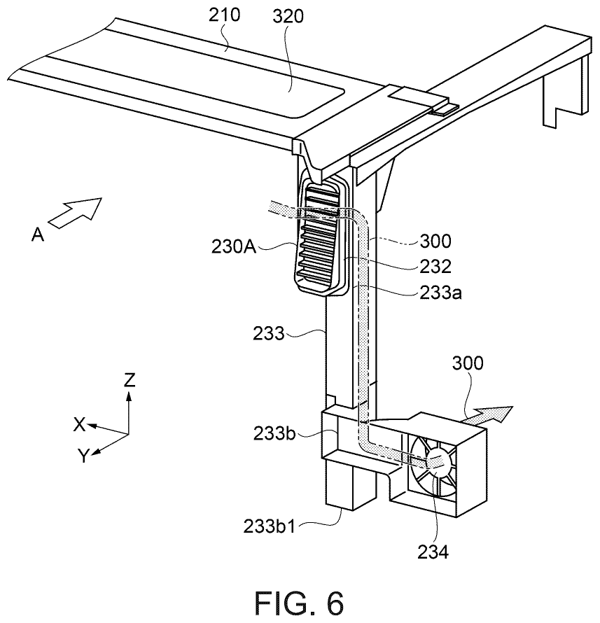

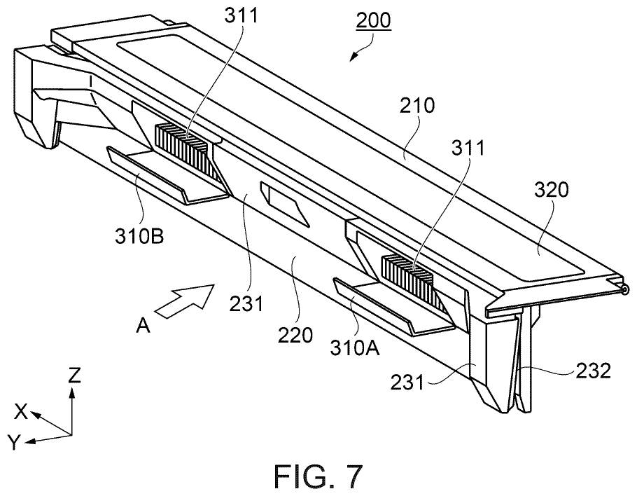

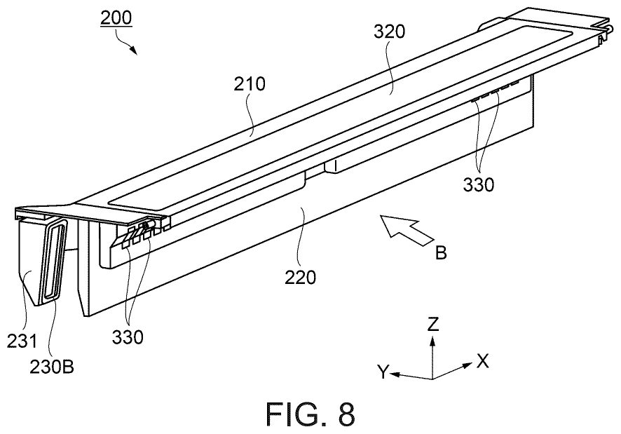

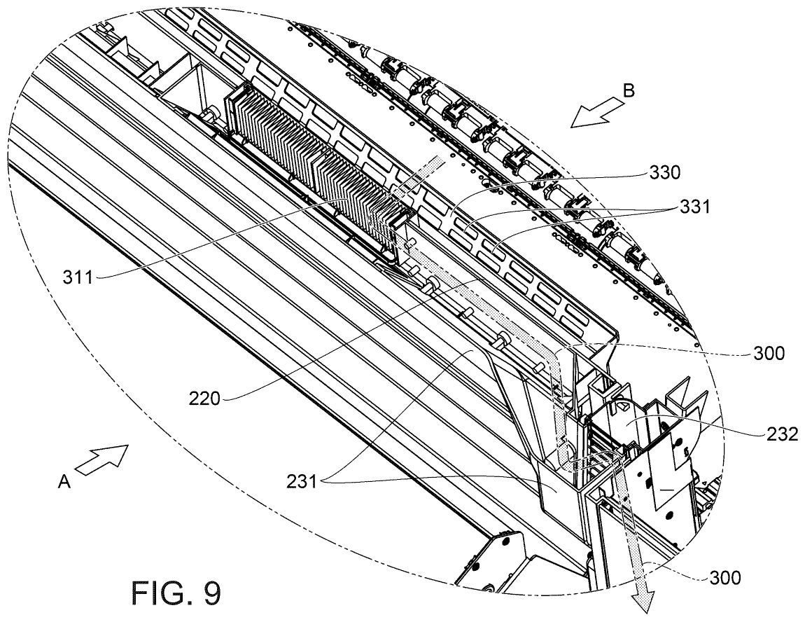

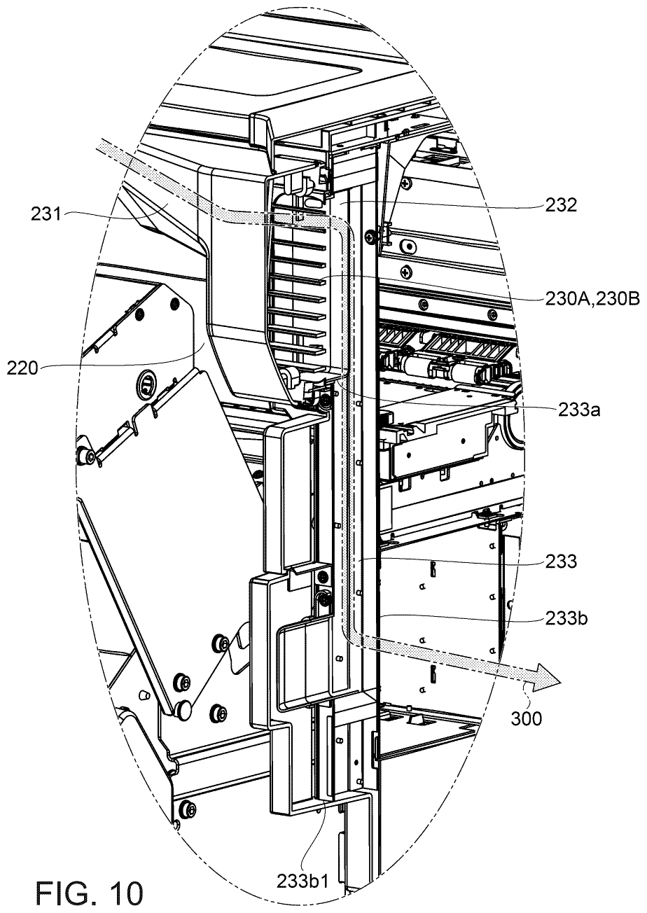

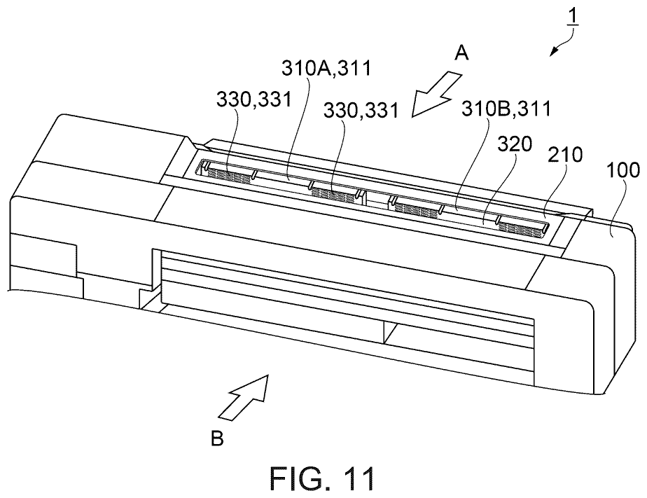

Note that FIG. 4 shows configuration when the opening and closing cover 200 of the housing 100 is closed. FIG. 5 shows configuration of the opening and closing cover 200 and an inner duct 232 when the opening and closing cover 200 is opened. FIG. 6 shows configuration of the inner duct 232 including a vertical duct 233. FIG. 7 shows configuration of a first opening and closing section 310A, a second opening and closing section 310B, and the mist filter 311, which are disposed in the opening and closing cover 200. FIG. 8 shows a configuration of the opening and closing cover 200 viewed from the inner duct 232 side, that is, the rear surface side B. FIG. 9 shows a configuration when the first partition 210 of the opening and closing cover 200 is removed. FIG. 10 shows cross-sectional configuration of the inner duct 232 and the vertical duct 233. FIG. 11 shows internal configuration of the housing 100 as viewed from a window 320 provided in the first partition 210.

As shown in FIG. 4, the opening and closing cover 200, as described above, includes the first partition 210 constituting a part of the top surface 100a of the housing 100 and the second partition 220 constituting a part of the front side A (shown in FIG. 3) of the housing 100. In a state where the opening and closing cover 200 is closed, the transport path is positioned in the-Z direction of the second partition 220, and a gap necessary for discharging the medium 2 from the housing 100 is provided. The second partition 220 may be formed of a transparent component.

The first partition 210 has the window 320 for making the inside of the housing 100 visible from the outside of the housing 100. The window 320 is made of, for example, transparent glass or transparent synthetic resin.

Outer ducts 231 serving as ducts (shown in FIG. 9) are fixed to the outer side of the second partition 220, that is, to the +Y direction side. To be specific, a right duct 231A is provided on the right side of the second partition 220, that is, in the −X direction. A left duct 231B is provided on the left side of the second partition 220, that is, in the +X direction.

The first opening and closing section 310A and the second opening and closing section 310B for opening and closing the outer duct 231 are provided on the front side of the outer duct 231. When the first opening and closing section 310A and the second opening and closing section 310B are opened, the mist filters 311 that adsorb mist inside the housing 100 are arranged detachably attached inside the outer ducts 231 (see FIGS. 7 and 9).

The mist filter 311 arranged inside of the outer duct 231 corresponding to the open and closed position of the first opening and closing section 310A and the mist filter 311 arranged inside of the outer duct 231 corresponding to the open and closed position of the second opening and closing section 310B have the same shape. Since the shapes of the mist filters 311 are the same, they can be used interchangeably even if replaced. Since the same mist filter 311 is used, it can be installed in either the right duct 231A or the left duct 231B. For example, if the adhesion state of the mist differs depending on the scanning range of the head 25, the usage can be equalized by exchanging the mist filters 311 with each other, thereby extending their lifespan.

As shown in FIG. 5, the inner duct 232 communicating with the outer duct 231 is fixed to the housing 100. Connecting sections 230 that couple the outer duct 231 and the inner duct 232 are provided at both end sections of the second partition 220 in the X direction (shown in FIG. 4).

As shown in FIG. 9, the second partition 220 of the opening and closing cover 200 is provided with a suction section 330 for sucking gas 300 that is inside the housing 100. The gas 300 includes mist remaining in the housing 100 when the ink is ejected from the nozzle 28 onto the medium 2. The suction section 330 and the outer duct 231 communicate with each other via the mist filter 311.

Specifically, the gas 300 suctioned from the suction section 330 passes through the mist filter 311, which adsorbs the mist contained in the gas 300. The gas 300 that has passed through the mist filter 311 passes through the outer duct 231 and enters the inner duct 232 via the connecting section 230. The gas 300 that has entered the inner duct 232 passes through the vertical duct 233 (shown in FIG. 6) and is discharged to the outside of the housing 100 via an airflow generation section 234 such as an exhaust fan.

As shown in FIG. 5, the inner duct 232 has an inner connecting opening section 230A that opens toward the front side A and that is coupled to the outer duct 231. In particular, the inner connecting opening section 230A is inclined to face the front side A and upwards, that is, in the +Z direction. In other words, the inner connecting opening section 230A is inclined obliquely upward. As shown in FIG. 8, the outer duct 231 has an outer connecting opening section 230B configured to come into contact with and separate from the inner connecting opening section 230A in accordance with the opening and closing of the opening and closing cover 200.

As shown in FIG. 6, the inner duct 232 has the vertical duct 233. The vertical duct 233 communicates with the airflow generation section 234. That is, the vertical duct 233 is arranged closer to the airflow generation section 234 than is the inner connecting opening section 230A. In other words, the vertical duct 233 is arranged between the flow path connecting the inner connecting opening section 230A and the airflow generation section 234.

The vertical duct 233 is made of, for example, a hollow angular member. The vertical duct 233 also functions as a frame constituting the housing 100.

As described above, since the vertical duct 233 is provided, the gas 300 passing through the opening and closing cover 200 from the suction section 330 can be discharged to the lower outside of the housing 100 via the vertical duct 233. Thus, the gas 300, which contains mist remaining inside the housing 100, can be removed.

Since the vertical duct 233 is a hollow angular member, it can serve as a frame for the housing 100, allowing the gas 300 to be discharged to the lower side of the housing 100. In addition, since the vertical duct 233 functions as a frame, the material used can be reduced, and the cost can be reduced.

As shown in FIGS. 5 and 6, the vertical duct 233, which is formed of the angular member, has an upper opening 233a, which opens over a plurality of surfaces, and a lower opening 233b, which is formed below the upper opening 233a and opens over a plurality of surfaces. Specifically, for example, the upper opening 233a is opened over two side surfaces of an angular member that extends along the Z direction. The lower opening 233b is opened, for example, across two side surfaces of an angular member that extends along the Z direction. When the opening is provided over a plurality of surfaces, the opening area can be larger than that in the case where the opening is provided in one surface.

The gas 300 flowing from the inner connecting opening section 230A flows into the upper opening 233a. The lower opening 233b allows the gas 300 to flow toward the airflow generation section 234. The lower opening 233b is formed above a lower end 233b1 of the angular member.

As described above, since the angular member having the upper opening 233a and the lower opening 233b is used, the gas 300 inside the housing 100 can be discharged toward the airflow generation section 234 while changing the flow direction. The lower opening 233b is formed above the lower end 233b1. In other words, the vertical duct 233 extends below the lower opening 233b. Therefore, a lightweight substance such as gas 300 changes its direction from the lower opening 233b provided on the way of the vertical duct 233 toward the direction of the airflow generation section 234 and flows out. However, a heavy solid substance falls within the vertical duct 233 to a position below the lower opening 233b due to gravity. In the present embodiment, since the inner connecting opening section 230A is inclined obliquely upward, there is a possibility that a foreign matter enters from the inner connecting opening section 230A. However, when the foreign substance passes through the vertical duct 233, it falls below the lower opening 233b and does not flow out toward the airflow generation section 234. That is, the foreign matter can be caught below the lower opening 233b in the vertical duct 233. By this, it is possible to reduce the contact of the entering foreign matter with the airflow generation section 234, and to reduce the occurrence of failure.

Next, the configuration of the suction section 330 and the mist filter 311 as viewed from the window 320 of the first partition 210 will be described with reference to FIG. 11.

As shown in FIG. 11, the first partition 210 of the housing 100 has a transparent window 320 for visually checking the inside of the housing 100. The suction section 330 is provided inside the second partition 220 (shown in FIG. 9). The suction section 330 is provided with a plurality of suction holes 331 for sucking the gas 300 that is inside the housing 100.

The mist filter 311 is arranged between the suction section 330 and the outer duct 231. With this arrangement, the mist filter 311 can be visually checked from the inside of the housing 100 through the suction hole 331. In other words, the suction hole 331 can be seen through the transparent window 320 of the first partition 210, allowing the degree of contamination of the mist filter 311, or the adhesion state of the mist, to be checked via the suction hole 331.

As described above, the printing device 1 according to the present embodiment includes a head 25 that is housed in a housing 100 and that ejects liquid onto the medium 2; an opening and closing cover 200 that includes a first partition 210 constituting a part of a top surface 100a of the housing 100 and a second partition 220 constituting a part of a front side A of the housing 100, and that opens and closes the housing 100; a suction section 330 configured to suck the gas 300 that is inside of the housing 100; an outer duct 231 that is fixed to the second partition 220 and that communicates with the suction section 330; and a mist filter 311 arranged in the outer duct 231, wherein the outer duct 231 has the opening and closing sections 310A and 310B, and the mist filters 311 are detachably attached to the outer duct 231 through the opening and closing sections 310A and 310B.

According to this configuration, since the outer duct 231 of the second partition 220 has the opening and closing sections 310A and 310B, and the mist filters 311 are arranged in the opening and closing sections 310A and 310B, the mist filters 311 can be replaced from the front side A of the housing 100. In addition, it is possible to check the amount of mist adhered to the mist filter 311 only by opening the opening and closing sections 310A and 310B on the front side A. Therefore, a complicated configuration is not required, the adhesion state of the mist can be relatively easily grasped, and the mist filter 311 can be easily replaced.

In the printing device 1 of the present embodiment, it is desirable that a plurality of outer ducts 231 are provided, and the mist filters 311 disposed in the outer ducts 231 have the same shape. According to this configuration, since the shapes of the mist filter 311 arranged in the plurality of outer ducts 231 are the same, even in a case where the mist filter 311 is replaced, the mist filter can be commonly used for the plurality of outer ducts 231 and can be easily replaced. Even in a case where the degree of contamination is biased depending on the place where the mist filter 311 is arranged, the mist filters can be replaced between the plurality of ducts.

In the printing device 1 of the present embodiment, it is desirable that the outer ducts 231 include the right duct 231A, which is fixed to the right side when facing the front, and a left duct 231B, which is fixed to the left side. According to this configuration, since the right duct 231A and the left duct 231B are provided and the common mist filter 311 is used for the ducts, the mist filter can be attached to either the right duct 231A or the left duct 231B. For example, if the adhesion state of the mist differs depending on the scanning range of the head 25, the usage can be equalized by exchanging the mist filters 311 with each other, thereby extending the lifespan of the mist filters 311.

In the printing device 1 of the present embodiment, it is desirable that the first partition 210 has the window 320 through which the inside of the housing 100 can be visually checked and that is provided so that the suction section 330 can be visually checked through the window 320. According to this configuration, for example, since the window 320 is made of a transparent component, the suction section 330 can be visually checked from a part of the top surface 100a of the housing 100, that is, the window 320, and thus it is possible to check the condition of the mist adhering on the mist filter 311 without opening the opening and closing sections 310A and 310B. Therefore, for example, even during printing, it is possible to check the degree of contamination of the mist filter 311.

In the printing device 1 of the present embodiment, it is desirable that the suction section 330 has the suction hole 331 and is provided so that the mist filter 311 can be visually checked through the window 320 and the suction hole 331. According to this configuration, for example, since the mist filter 311 is arranged adjacent to the suction hole 331, it is possible to grasp the degree of contamination of the mist filter 311 by checking the inside of the housing 100 from a part of the top surface 100a.

What is claimed is:

1. A printing device comprising:
a head that is housed in a housing and that ejects liquid onto a medium;
an opening and closing cover that includes a first partition forming a part of a top surface of the housing and a second partition forming a part of a front side of the housing, and that opens and closes the housing;
a suction section configured to suck gas from inside the housing;
a duct fixed to the second partition and communicated with the suction section; and
a mist filter arranged in the duct, wherein
the duct has an opening and closing section, and
the mist filter is detachably attached to the duct through the opening and closing section.

2. The printing device according to claim 1, wherein
the duct is provided in plural form, and
the mist filters arranged within the ducts have the same shape.

3. The printing device according to claim 2, wherein
the ducts include a right duct fixed to the right side of the front surface and a left duct fixed to the left side of the front surface.

4. The printing device according to claim 1, wherein
the first partition
has a window for visually checking the interior of the housing and
is arranged such that the suction section is visible through the window.

5. The printing device according to claim 4, wherein
the suction section has a suction hole, and
the mist filter is positioned to be visible through the window and the suction hole.
